(19) United States
(12) Patent Application Publication
(10) Pub. No.: US 2018/0345464 A1
(43) Pub. Date: Dec. 6, 2018

(54) HAND TOOL

(71) Applicant: Jason Chang, Taichung (TW)

(72) Inventor: Jason Chang, Taichung (TW)

(21) Appl. No.: 15/613,153

(22) Filed: Jun. 3, 2017

(51) Int. Cl. B25B 23/00; B25B 23/16; B25B 15/04; B25G 1/10; B25B 13/46

(52) U.S. Cl. CPC B25B 23/0042; B25B 23/16; B25B 13/461; B25B 23/0028; B25G 1/102; B25B 15/04

(57) ABSTRACT

A hand tool includes two parts with a core received between the two parts to form a handle. A shank is connected to the handle. The shank includes a first engaging portion which is connected to the first opening of the two parts and the first aperture of the core. The third engaging portion is engaged with the second opening and the second aperture. The shank, the two parts and the core are well connected to each other so as to obtain a hand tool with simple structure.

### BACKGROUND OF THE INVENTION

### 1. Fields of the invention

The present invention relates to a hand tool, and more particularly, to a hand tool composed of a core with two parts accommodating the core to form the handle of the hand tool, and a shank is connected to the handle.

### 2. Descriptions of Related Art

The conventional wrench is disclosed in U.S. Pat. No. 7,444,905 and comprises a head portion, a handle portion, and a neck portion between the head portion and the handle portion, with the head portion being solid, with the handle portion being hollow and including a front portion contiguous to the neck portion, a rear portion adapted to be gripped by a user and a necking portion between the front and rear portions, and with the front portion having a wall thickness greater than that of the rear portion, and with the necking portion having a wall thickness greater than that of the rear portion and smaller than that of the front portion; wherein the rear portion of the handle portion including an open rear end defining a rear end opening, with an annular extension extending rearward from a circumference of the rear end and bent inwardly as to define a hole; wherein the front portion, the neck portion, the rear portion and the rear end of the handle portion are integrally formed as single and inseparable component of a same material.

The front end has an outer diameter the same as that of the rear end of the neck portion. The front portion has a wall thickness greater than that of the necking portion, which, in turn, is greater than that of the rear portion. The smaller gradient section has a wall thickness greater than that dl of the rear portion, and the larger gradient section has a wall thickness greater than that of the small gradient section and smaller than that of the front portion. The smaller gradient section has increased wall thickness from the rear end thereof toward the front end thereof. The larger gradient section has increased wall thickness from the rear end thereof toward the front end thereof. The wall thickness of the front portion is two times of that of the rear portion. The smaller gradient section has an outer diameter greater than that of the rear portion, the larger gradient section has an outer diameter greater than that of the smaller gradient section, and the front portion has an outer diameter greater than that of the larger gradient section. This arrangement in thicknesses and diameters makes the manufacturing processes be complicated. Besides, the inner mold set is supposed put into the handle portion, and the outer mold set is mounted to the outside of the handle portion. However, due to the precise specifications of the front portion, the necking portion and the rear portion of the handle portions, the thickness is difficult to control and this will take a longer time when being manufactured.

The present invention intends to provide a hand tool which is designed to eliminate the shortcomings mentioned above.

### SUMMARY OF THE INVENTION

The present invention relates to a hand tool and comprises two parts which are welded to each other to form a room therebetween. Each part has a first opening defined in the first end thereof, and a second opening defined in the second end thereof. The first and second openings communicate with the room and share a common axis. A core is located in the room and contacts inside of the room to form a handle. The core includes multiple first plates and multiple second plates which transversely intersect the first plates. The core includes a first aperture located corresponding to the first opening. The core includes a second aperture located corresponding to the second opening. An elongate shank is connected to the core and the two parts of the handle. The shank includes a front section which is an extension rod, a middle section which is a first engaging portion, and a rear section which is a third engaging portion. The extension rod has a driving portion which extends beyond the two parts. A second engaging portion is formed at the conjunction portion between the first engaging portion and the extension rod. The second engaging portion is ir-rotatably connected to the first opening and the first aperture. The third engaging portion is ir-rotatably connected to the second opening and the second engaging aperture.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the hand tool of the present invention;

FIG. 2 is a perspective view to show the hand tool of the present invention, wherein one of the two parts is removed;

FIG. 3 is a top view of the hand tool in FIG. 2;

FIG. 4 is a perspective view to show the hand tool of the present invention;

FIG. 5 is a side view of the hand tool of the present invention;

FIG. 6 is a cross sectional view, taken along line 6-6 in FIG. 5;

FIG. 7 is a perspective view to show the second embodiment of the hand tool of the present invention;

FIG. 8 is a perspective view to show the third embodiment of the hand tool of the present invention;

FIG. 9 is a perspective view to show the fourth embodiment of the hand tool of the present invention;

FIG. 10 is a perspective view to show the fifth embodiment of the hand tool of the present invention;

FIG. 11 is an exploded view to show the sixth embodiment of the hand tool of the present invention;

FIG. 12 is a perspective view to show the sixth embodiment of the hand tool of the present invention, wherein one of the two parts is removed;

FIG. 13 is an exploded view to show the seventh embodiment of the hand tool of the present invention;

FIG. 14 shows the core of the handle of the seventh embodiment of the hand tool of the present invention;

FIG. 15 is an exploded view to show the eighth embodiment of the hand tool of the present invention, and

FIG. 16 shows the core of the handle of the eighth embodiment of the hand tool of the present invention.

### DETAILED DESCRIPTION OF THE PREFERRED EMBODIMENT

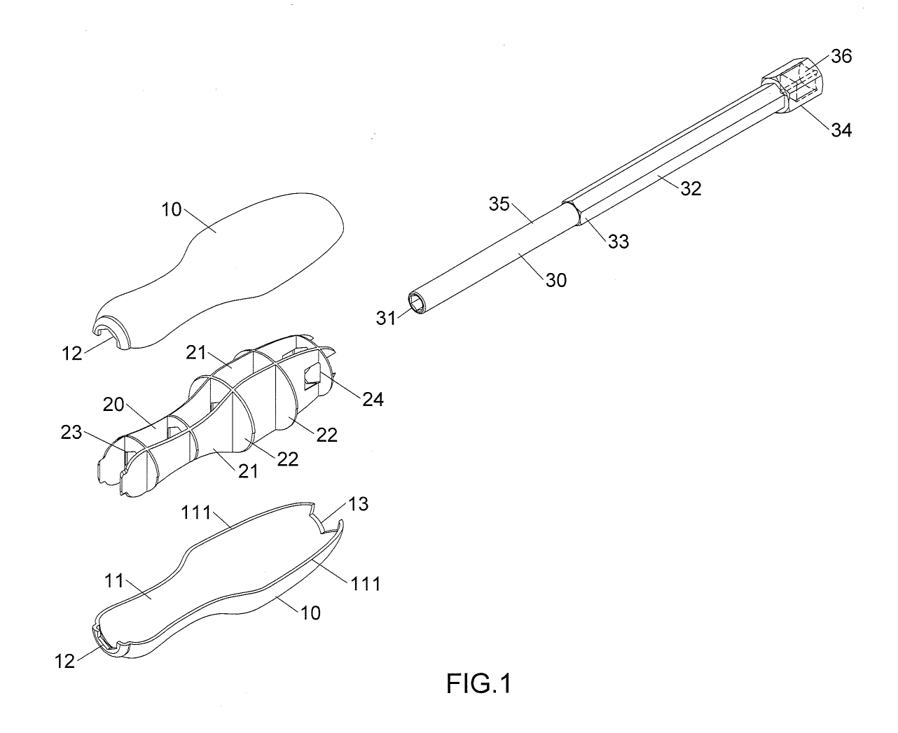

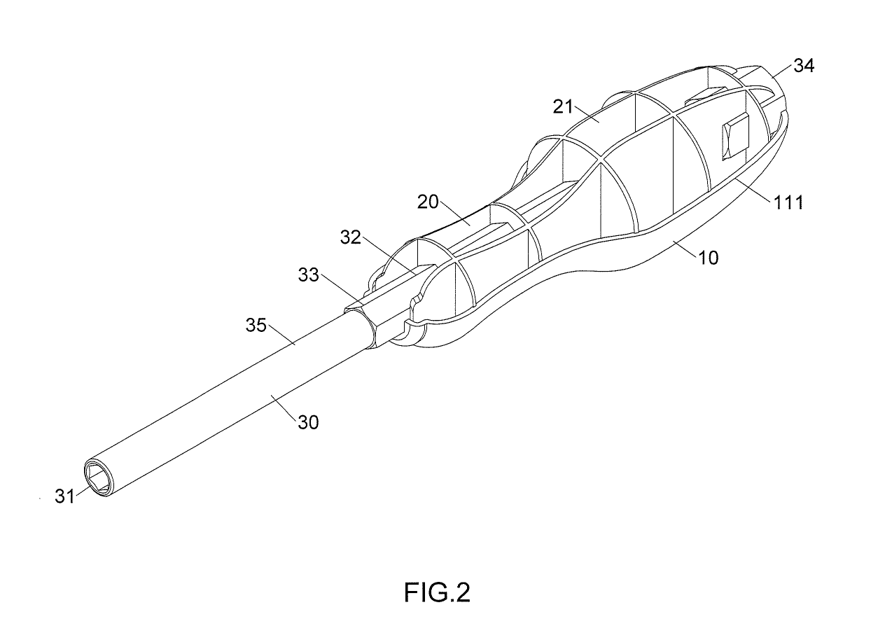

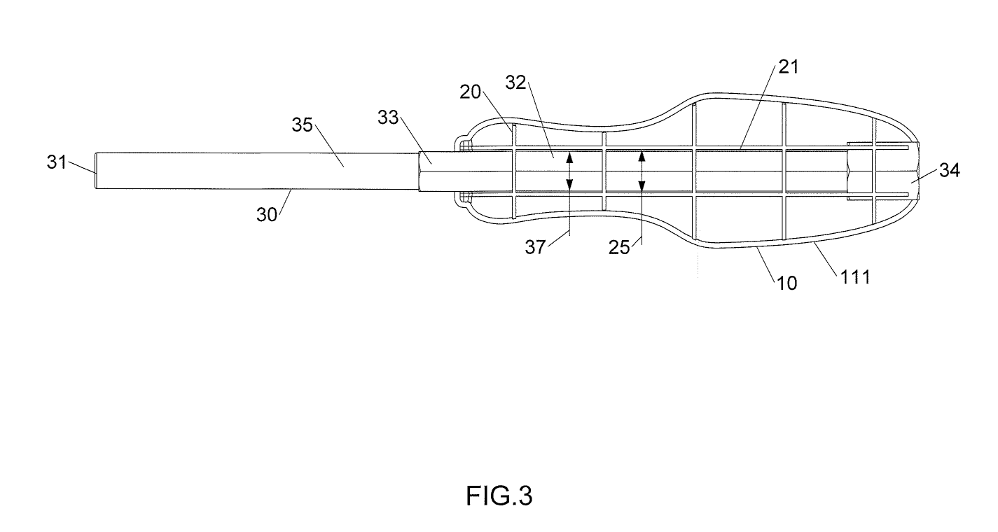

Referring to FIGS. 1 to 3, the hand tool of the present invention comprises two parts 10, a core 20 and a shank 30. The two parts 10 each are pressed from a metal plate and include a welding portion 111. A room 11 is defined between the two parts 10. The two parts 10 are connected to each other by welding the two respective welding portions 111 to each other. The welding portions 111 are then polished to have better appearance. Each part 10 has a first opening 12 defined in the first end thereof, and a second opening 13 defined in the second end thereof. The first and second openings 12, 13 communicate with the room 11 and share a common axis. The first opening 12 and the second opening 13 of each of the two parts 10 are a semi-hexagonal recess. When the two parts 10 are connected to each other, the two respective semi-hexagonal recesses of the two first openings 12 form a hexagonal hole, and the two respective semi-hexagonal recesses of the two second openings 13 form a hexagonal hole.

The core 20 is located in the room 11 and contacts the inside of the room 11 to form a handle. The core 20 includes multiple first plates 21 and multiple second plates 22 which transversely intersect the first plates 21. The core 20 includes a first aperture 23 which is located corresponding to the first opening 12, and the core 20 also includes a second aperture 24 which is located corresponding to the second opening 13. The shape of the first aperture 23 is made to be corresponding to the shape of the first opening 12. Similarly, the shape of the second aperture 24 is made to be corresponding to the shape of the second opening 13. The first and second apertures 23, 24 are formed between the two first plates 21. The core 20 is an extruded Aluminum product and is shaped to match the inside of the two parts 10.

The elongate shank 30 is connected to the core 20 and the two parts 10 of the handle. The shank 30 includes a front section which is an extension rod 35, a middle section which is a first engaging portion 32, and a rear section which is a third engaging portion 34. The extension rod 35 has a driving portion 31 which extends beyond the two parts 10. A second engaging portion 33 is formed at the conjunction portion between the first engaging portion 32 and the extension rod 35. The second engaging portion 33 is ir-rotatably connected to the first opening 12 and the first aperture 23. The third engaging portion 34 is ir-rotatably connected to the second opening 13 and the second engaging aperture 24. The first engaging portion 32 includes a hexagonal cross section which is the same as the shape of the first opening 12. The second engaging portion 33 protrudes beyond the first opening 12. The third engaging portion 34 includes a hexagonal cross section which is the same as the shape of the second opening 13 and extends beyond the second opening 13. The outer diameter of the third engaging portion 34 is larger than that of each of the first and second engaging portions 32, 33. A rectangular engaging recess 36 is formed at an end of the third engaging portion 34.

The first plates 21 are two parallel plates with a gap 25 formed therebetween. The second plates 22 are perpendicularly connected to the two first plates 21. The gap between the two first plats 21 is larger than the width 37 of the first engaging portion 32, so that the first engaging portion 32 is located between the two first plates 21.

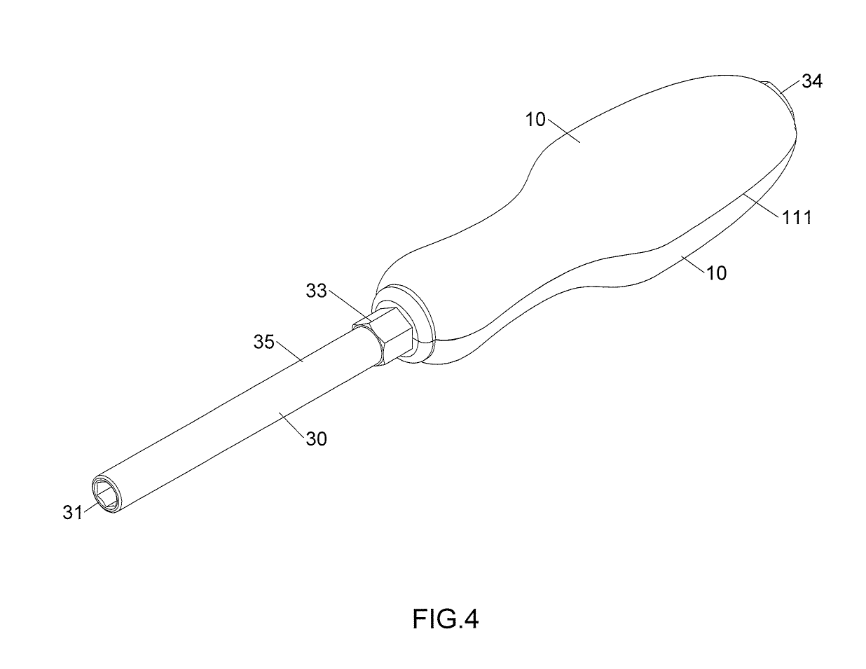

As shown in FIGS. 4 to 6, the two parts 10 form a handle and the core 20 is located in the room 11. The shank 30 is connected to the two parts 10 and the core 20. The driving portion 31 extends beyond the parts 10. The first engaging portion 32 extends in the first opening 12 and the first aperture 23. The second engaging portion 33 extends beyond the first opening 12. The third engaging portion 34 extends in the second opening 13 and the second aperture 24. The third engaging portion 34 partially extends beyond the second opening 13. The extension rod 35 extends beyond the parts 10.

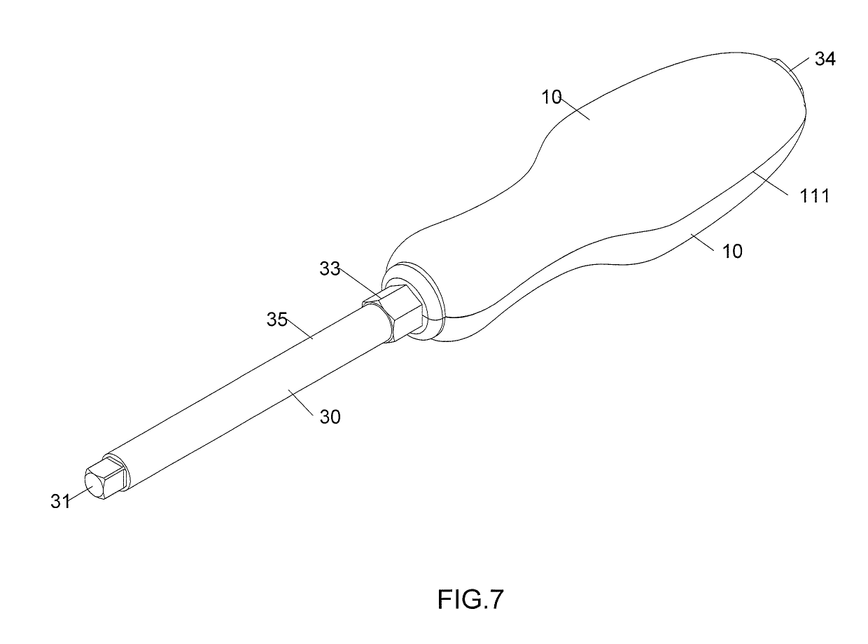

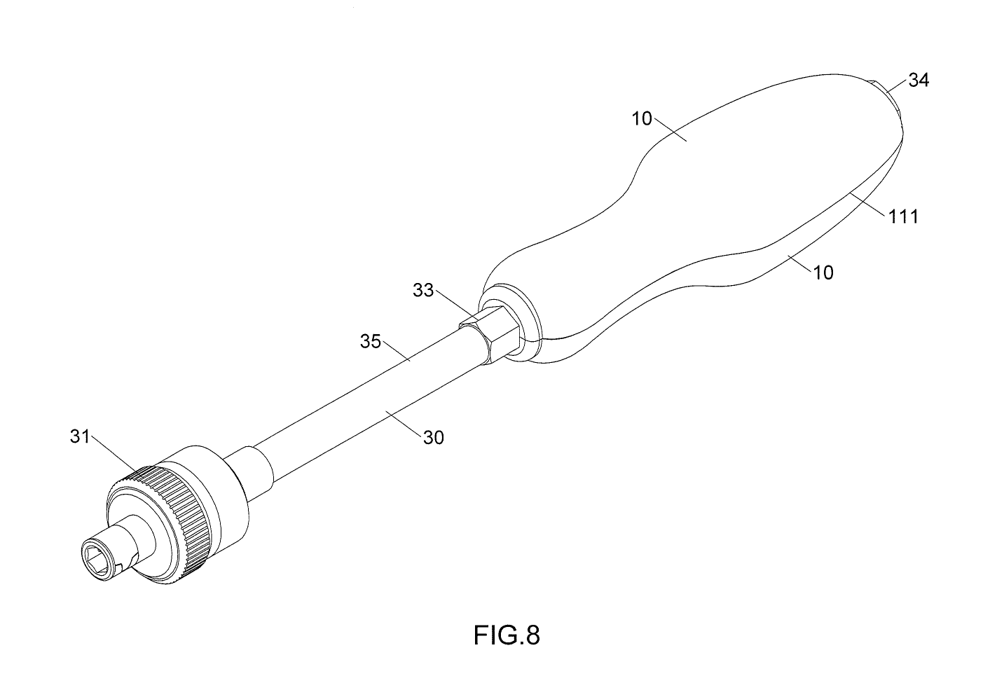

As shown in FIG. 7, the driving portion 31 is a rectangular protrusion, and the driving portion 31 is a bit whose operational directions can be switched.

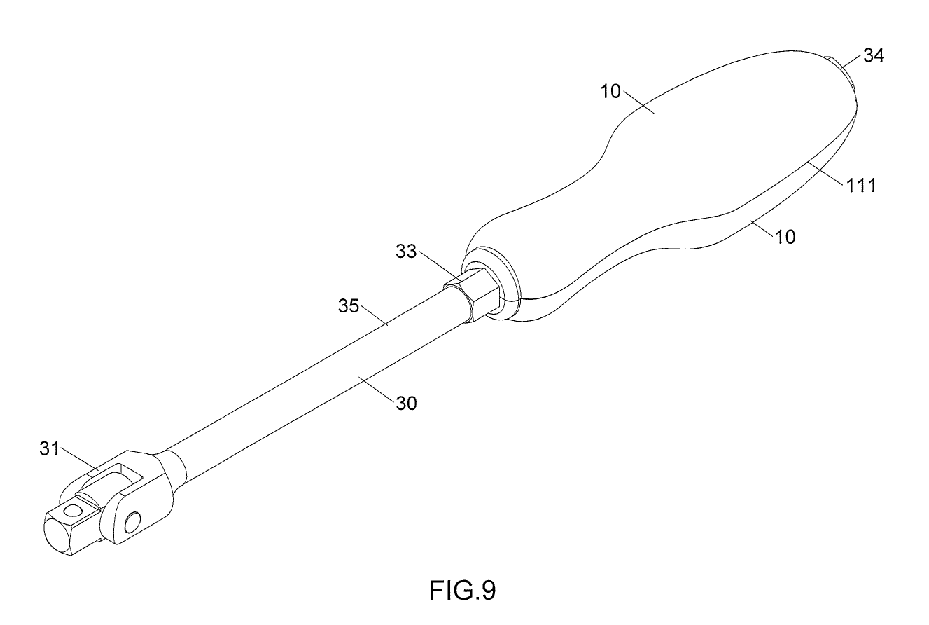

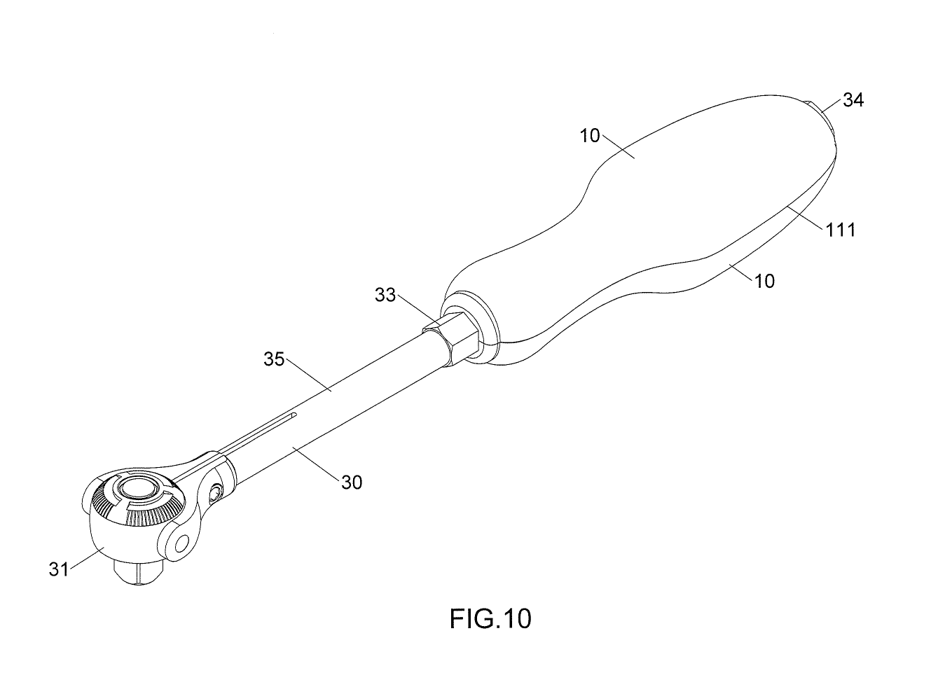

As shown in FIGS. 9 and 10, the driving portion 31 is rotatable relative to the shank 30.

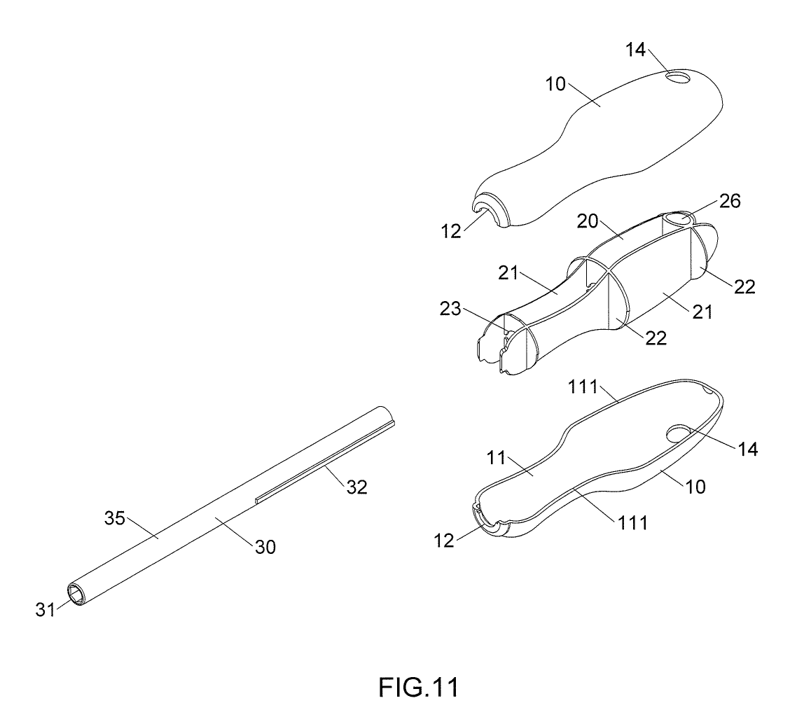

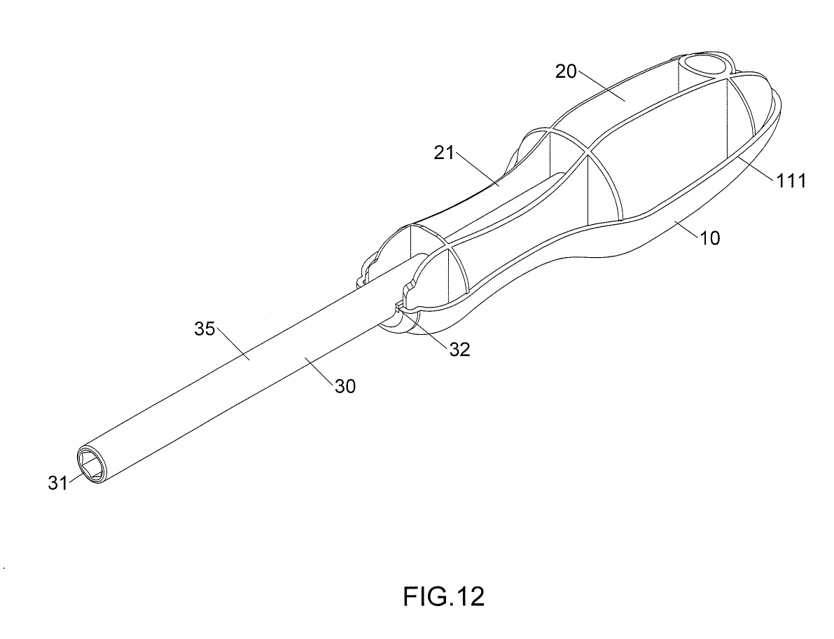

As shown in FIGS. 11 and 12, the two parts 10 each have a first hole 14 defined therethrough. The two respective first holes 14 are located corresponding to each other. The core 20 includes a second hole 26 which is located corresponding to the two respective first holes 14. The second holes 26 and the first holes 14 are used to hang the hand tool. The shank 30 is a cylindrical shank and includes a ridge which is formed on the first engaging portion 32 and extends along the direction parallel to the axis of the shank 30 and reaches the second and third engaging portions 33, 34.

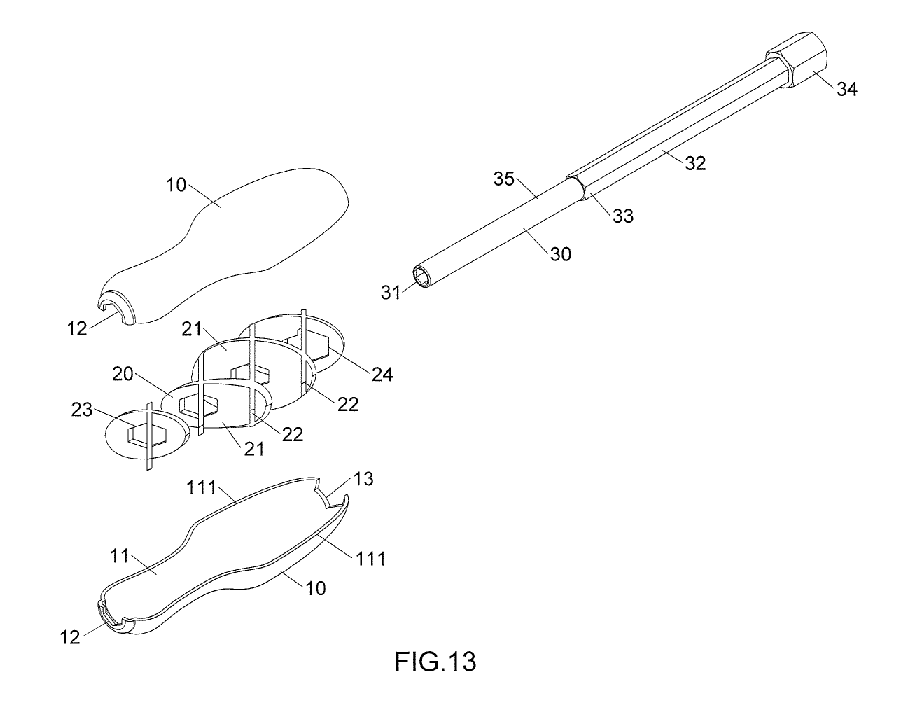

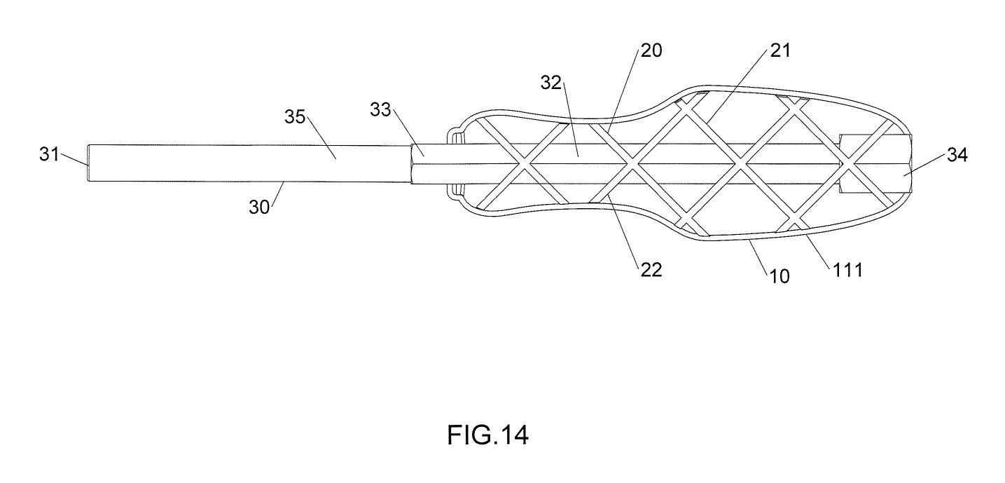

As shown in FIGS. 13 and 14, the number of the first plates 21 and the number of the second plates 22 are the same. At least two of the first plates 21 intersect to each other. At least two of the second plates 22 intersect to each other. At least one of the first plates 21 and at least one of the second plates 22 intersect to each other. Each of the first and second plates 21, 22 contacts the inside of the room 11.

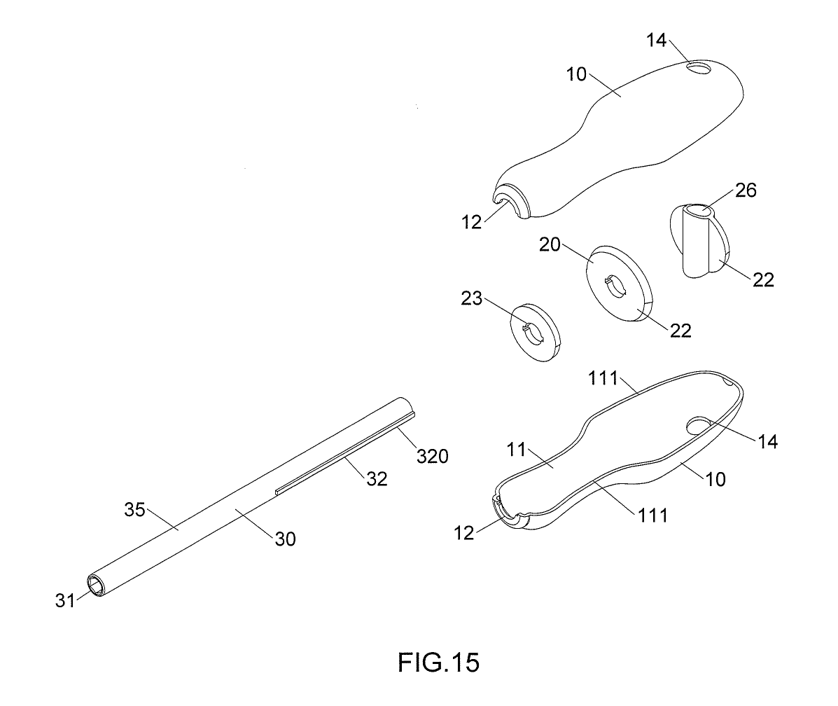

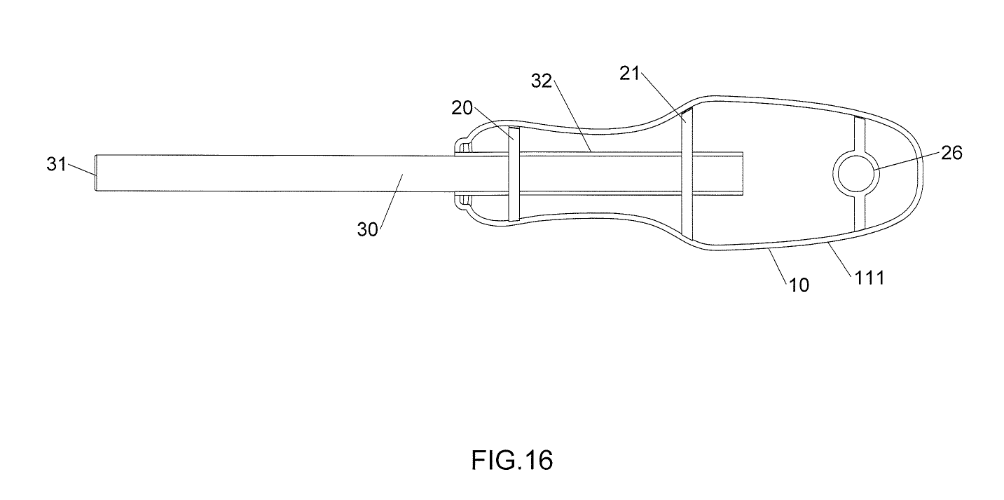

As shown in FIGS. 15 and 16, the first plates 21 and multiple second plates 22 are individual plates. The two parts 10 each have a first hole 14 defined therethrough. The two respective first holes 14 are located corresponding to each other. The core 20 includes three second plates 22 which contact the inside of the room 11. Two of the second plates 22 has a first aperture 23 which is located corresponding to the first opening 12. The third second plate 22 includes a second hole 26 which is in a form of a passage and located corresponding to the first hole 14. The first holes 14 and the second hole 26 are used to hang the hand tool.

In another embodiment, wherein the two parts 10 each are made by way of pressing and each have a pattern/logo formed on an outside thereof.

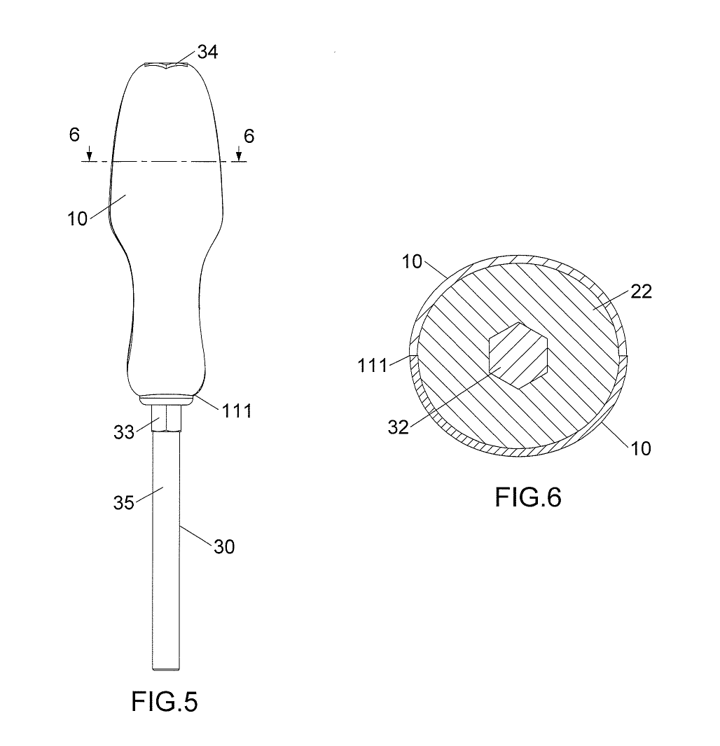

The two parts 10 each have a thin wall so that the handle is light in weight. The core 20 in the handle reinforces the strength of the handle. As shown in FIG. 6, the core in the room 11 reinforces the handle, and the shank 30 is firmly connected to the parts 10 and the core 20.

The two parts 10 are welded together and polished to have smooth outer appearance. The handle is durable and meets aesthetic purpose. The handle is shaped to provide a comfort grip. The parts 10 are made of metal plates so that grease is not easily attached to the parts 10. As shown in FIG. 4, the third engaging portion 33 extends beyond the two parts 10 so as to be engaged with other hand tools.

While we have shown and described the embodiment in accordance with the present invention, it should be clear to those skilled in the art that further embodiments may be made without departing from the scope of the present invention.

What is claimed is:

1. A hand tool comprising:
two parts connected to each other to form a room therebetween, each part being pressed from a metal plate and including at least one welding portion, the two parts connected to each other by welding the two respective at least one welding portions to each other, each part having a first opening defined in a first end thereof, and a second opening defined in a second end thereof, the first and second openings communicating with the room and sharing a common axis;
a core located in the room and contacting an inside of the room to form a handle, the core including multiple first plates and multiple second plates which transversely intersect the first plates, the core having a first aperture which is located corresponding to the first opening, the core having a second aperture which is located corresponding to the second opening, a shape of the first aperture being corresponding to a shape of the first opening, a shape of the second aperture being corresponding to a shape of the second opening, and
an elongate shank connected to the core and the two parts of the handle, the shank including a front section which is an extension rod, a middle section which is a first engaging portion, and a rear section which is a third engaging portion, the extension rod having a driving portion which extends beyond the two parts, a second engaging portion being formed at a conjunction portion between the first engaging portion and the extension rod, the second engaging portion ir-rotatably connected to the first opening and the first aperture, the third engaging portion ir-rotatably connected to the second opening and the second engaging aperture.

2. The hand tool as claimed in claim 1, wherein the first opening of each of the two parts is a semi-hexagonal recess, when the two parts are connected to each other, the two respective semi-hexagonal recesses of the two first openings form a hexagonal hole, the first engaging portion includes a hexagonal cross section.

3. The hand tool as claimed in claim 1, wherein the second opening of each of the two parts is a semi-hexagonal recess, when the two parts are connected to each other, the two respective semi-hexagonal recesses of the two second openings form a hexagonal hole, the third engaging portion includes a hexagonal cross section.

4. The hand tool as claimed in claim 1, wherein the first plates are two parallel plates with a gap formed therebetween, the second plates are perpendicularly connected to the two first plates, the first and second apertures are formed between the two first plates, the gap between the two first plats is larger than a width of the first engaging portion, so that the first engaging portion is located between the two first plates.

5. The hand tool as claimed in claim 1, wherein the core is an extruded Aluminum product.

6. The hand tool as claimed in claim 1, wherein the first plates and multiple second plates are individual plates.

7. The hand tool as claimed in claim 1, wherein the driving portion includes a hexagonal recess.

8. The hand tool as claimed in claim 1, wherein the driving portion is a rectangular protrusion.

9. The hand tool as claimed in claim 1, wherein the driving portion is a bit whose operational directions can be switched.

10. The hand tool as claimed in claim 1, wherein the driving portion is rotatable relative to the shank.

11. The hand tool as claimed in claim 1, wherein the two parts each have a first hole defined therethrough, the two respective first holes are located corresponding to each other, the core includes a second hole which is located corresponding to the two respective first holes.

12. The hand tool as claimed in claim 1, wherein the shank is a cylindrical shank and includes a ridge which is formed on the first engaging portion and extends along a direction parallel to an axis of the shank and reaches the second and third engaging portions.

13. The hand tool as claimed in claim 1, wherein at least two of the first plates intersect to each other, at least two of the second plates intersect to each other, at least one of the first plates and at least one of the second plates intersect to each other, each of the first and second plates contacts the inside of the room.

14. The hand tool as claimed in claim 1, wherein the two parts each are made by way of pressing and each have a pattern/logo formed on an outside thereof.

15. The hand tool as claimed in claim 1, wherein an outer diameter of the third engaging portion is larger than that of each of the first and second engaging portions, a rectangular engaging recess is formed at an end of the third engaging portion.
